(19) United States
(12) Patent Application Publication
(10) Pub. No.: US 2016/0056996 A1
(43) Pub. Date: Feb. 25, 2016

(54) System and Method for Implementing High Availability of Server in Cloud Environment

(71) Applicant: P. Ashok Anand, Chennai (IN)

(72) Inventors: P. Ashok Anand, Chennai (IN); Giribabu Yerradla, Chennai (IN); Gowri Shankar, Chennai (IN)

(21) Appl. No.: 14/784,392

(22) PCT Filed: Apr. 15, 2014
(86) PCT No.: PCT/IN2014/000237

§ 371 Date: Oct. 14, 2015

(30) Foreign Application Priority Data
Apr. 15, 2013 (IN) 1684/CHE/2013

(51) Int. Cl. H04L 12/24; H04L 29/08

(52) U.S. Cl. CPC H04L 41/0668; H04L 67/10

(57) ABSTRACT

This invention relates to a system and method for implementing high availability of the server/nodes in a cluster of a cloud network. An application with respect to a customer/client can be received at a high availability manager of a cluster in a cloud network to assign the application to a server/node within the cluster. A seed server/node from a plurality of server/nodes within the cluster can be identified with respect to the application based on the application information and correlation identify of the customer. The seed server/node can be assigned with a primary server/node status to hereby communicate the cluster information with respect to the seed server/node to the plurality of server/node located with the cluster. A secondary server/node with respect to the application can be identified and assigned a secondary server/node status to thereby route the traffic of the seed server/node upon detecting a failure/alert is generated to effectively implement the high availability of server/nodes within the cluster of the cloud network.

### TECHNICAL FIELD

Embodiments are generally related to data processing systems and methods. Embodiments are also related to cloud computing platforms and networks. Embodiments are additionally related to methods for implementing high availability of servers in a cluster of a cloud computing environment.

### BACKGROUND OF THE INVENTION

Systems and method for implementing high availability of server/node within a cluster are adapted in a wide variety of computing environments to improve the availability of resources that the cluster provides. In general, High Availability (HA) clusters are a class of distributed systems that provide high availability for applications within a computing environment. The high availability is achieved using hardware redundancy to recover from single points of failure. High availability clusters generally include two or more server/nodes. High availability clusters are also referred to as Node Availability Management Systems for clusters. High availability systems manage both nodes and applications running on the nodes.

Conventionally, high availability systems operate by having redundant server/nodes which are used to provide service when the intended resources within the cluster fail to perform the execution of a requested application. For example, if a process within a node of the cluster fails to execute a requested application the process remain unavailable till an administrator restarts or redirect the application to an alternate server/node in the cluster. High availability clustering automates the process of re-starting/redirecting by detecting when a process or other resource has failed on another node, without requiring administrative intervention. Such high availability clusters often play a critical role in ensuring the availability of resources such as databases, file systems, network addresses, or other resources for applications which require a high degree of dependability, such as electronic commerce websites or other business applications.

The prior art systems and methods for implementing high availability of cluster recourses of a virtual computing environment are well-known in the art. Such prior art systems and methods typically run an application within a virtual machine on one physical node at a time and are run independently and unaware of their configuration as part of a high-availability cluster. Upon detection of a failure, traffic is rerouted through a redundant node and the application virtual machines are migrated from the failing node to another node using live migration techniques. Also, prior art systems and methods are provided for expressing high availability demand based on a probability of breach. Such an application typically filters the event messages and translates the events into probability of breach data.

Majority of such prior art systems and methods for implementing the high availability of nodes within a cluster adapt a redundant node for performing the application of a failure server/node. The process of migrating the application and functions with respect to a customer to a redundant node can be time consuming and wearisome. The prior art approach requires status polling of the server/nodes at the same time to decide the redundant node which leads to a large spike in the system load, which can even lower the responsiveness of the system. Secondly, the prior art systems are highly disadvantageous if a participating node of the cluster “drop-out” unexpectedly. Such a drop-out takes precious time to notice and verify that a node has disappeared. Such unexpected drop-out is highly risky to the uptime of the HA cluster, as there is a finite probability of some “glitch” occurring during the drop-out which could cause the failure of applications. Also, the prior art technologies may not be effectively implemented in the server architectures of cloud computing environment for implementing high availability of server/node within a cloud network.

Based on the foregoing, it is believed that a need exists for an improved high availability system for servers in a cloud network. A need also exists for an improved system and method for implementing high availability of servers/nodes within a cluster of a cloud network, as described in greater detail herein.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved high availability system for cloud networks.

It is another aspect of the disclosed embodiments to provide for an improved method for implementing high availability of servers in cloud networks.

It is further aspect of the disclosed embodiments to provide for an improved system and method for implementing high availability of server/nodes by creating a secondary image node of a primary node in a cluster of a cloud network.

The aforementioned aspects and other objectives and advantages can now be achieved as described herein. A system and method for implementing high availability of the server/nodes in a cluster of a cloud network, is described herein. An application with respect to a customer/client can be received at a high availability manager (HAM) of a cluster in a cloud network in order to assign the application to a server/node within the cluster. A seed server/node from a plurality of server/nodes within the cluster can be identified with respect to the application based on the application information and correlation identity of the customer. The seed server/node can be assigned with a primary server/node status in order to thereby communicate the cluster information with respect to the seed server/node to the plurality of server/node located within the cluster. A secondary server/node with respect to the application can be identified based on at least one server/node parameters and assigned a secondary server/node status in order to thereby route the traffic of the seed server/node upon detecting a failure/alert is generated in order to effectively implement the high availability of server/nodes within the cluster of the cloud network.

The high availability manager described herein can be a bridge architecture that is connected to a plurality of server/nodes within the cluster for monitoring the status and working of the server/nodes within the cluster of the cloud network. The high availability manager generates a message that includes the cluster information with respect to the seed server/node and transmits to the available server/nodes within the cluster by alerting the status of the seed node within the cluster. The high availability manager typically receives the applications with respect to the customer and effectively assigns the application to the appropriate seed server/node by ensuring the high availability of resources within the cluster.

The high availability manager also maintains the information of the secondary server/node with respect to the application by actively monitoring the operability and availability of the seed server/node. The secondary server/node can act as mirror server/node of the seed server/node in order thereby ensures the processing of the applications within the cluster in a failure mode. The seed server/node (or) the primary server/node within the cluster is determined based on the functional aspects of the application and the correlation identity of the customer.

The secondary server/node within the cluster is determined based on the server/node parameters including but not limited to, current usage history of the server/node, past usage history of the server/node and ping time of the server/node. Such as system and method for implementing high availability of server/nodes in a cluster can be effectively adapted in ensuring the availability of server/nodes such as databases, file systems, network addresses, or other resources for applications which require a high degree of dependability, such as electronic commerce websites and other business applications.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a graphical representation of a system for implementing high availability of server/nodes within a cluster of a cloud network, in accordance with the disclosed embodiments;

FIG. 2 illustrates a block diagram of the high availability manager for implementing high availability of server/node within a cluster of a cloud network, in accordance with the disclosed embodiments; and

FIG. 3 illustrates a high level flow chart of operations illustrating logical operational steps of a method for implementing high availability of server/node within a cluster of a cloud network, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

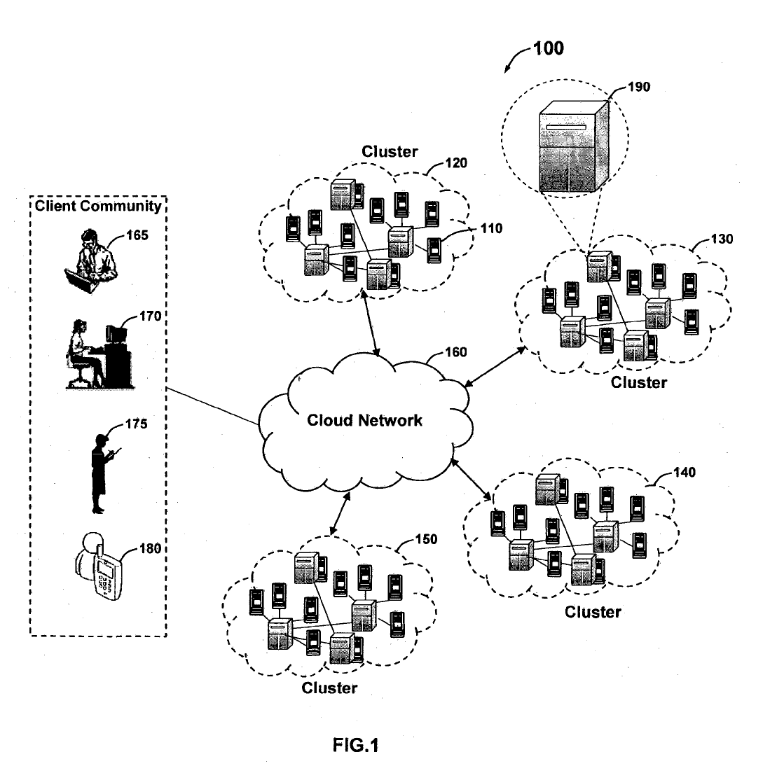

FIG. 1 illustrates a graphical representation of a system 100 for implementing high availability of server/nodes such as for example server/node 110 within a cluster such as the clusters 120-150 of a cloud network 160, in accordance with the disclosed embodiments. The embodiments and the pictorial representations provided in FIG. 1, depicts a cloud computing network 160 connected to one or more clusters 120-150 and client computers 165-180 in which the present invention may be implemented. The system 100 contains the cloud network 160, which is the medium used to provide communications links between various devices and computers connected together within the system 100.

The clusters 120-150 described herein can be a parallel or distributed system that comprises a collection of interconnected computers/servers, such as server 110 that is used as a single, unified computing unit. Members of the cluster 120-150 are referred to as server/node 110. In general, clustering may be used for parallel processing or parallel computing to simultaneously use two or more processors to execute an application or program. Clustering is a popular strategy for implementing parallel processing applications because it allows system administrators to leverage already existing computers and workstations.

Clustering also provides for increased scalability by allowing new components to be added as the system load increases. In addition, clustering simplifies the management of groups of systems and their applications by allowing the system administrator to manage an entire group as a single system. Clustering may also be used to increase the fault tolerance of the network. If one server/node suffers an unexpected software or hardware failure, another clustered server/node may assume the operations of the failed server/node. Thus, if any hardware of software component in the system fails, the user might experience a performance penalty, but will not lose access to the service.

The clients 165-180 may be, for example, personal computers or network computers users accessing the server/nodes of the clusters for data, such as boot files, operating system images, and applications with respect to the clients. Note that the system 100 may include additional clusters, server/nodes, clients, and other devices not shown. In the depicted example, the cloud network can be an Internet with a worldwide collection of networks and gateways that use the Transmission Control Protocol/Internet Protocol (TCP/IP) suite of protocols to communicate with one another.

At the heart of the Internet is a backbone of high-speed data communication lines between major nodes or host computers, consisting of thousands of commercial, government, educational, and other computer systems that route data and messages. Of course, cloud network also may be implemented as a number of different types of networks, such as for example, an intranet, a local area network (LAN), or a wide area network (WAN). FIG. 1 is intended as an example, and not as an architectural limitation for embodiments of the present invention.

A high availability manager 190 configured in association with the server/nodes 110 of the cluster 120-150 typically receives the applications with respect to the customer/client 165-180 of the cluster 120-150 in the cloud network 160 in order to assign the application 230 to a server/node 110 within the cluster 120-150. The application 230 with respect to the client is typically assigned to the server/node 110 by identifying a seed server/node 240 from the plurality of server/nodes 110 within the cluster 120-150 with respect to the application based on the application information and correlation identity of the customer.

The high availability manager 190 further assigns a primary server/node status on the seed server/node 240 in order to thereby communicate the cluster information with respect to the seed server/node 240 to the plurality of server/node 110 located within the cluster 120-150. The high availability manager 190 also identifies a secondary server/node 150 with respect to the application 230 based on at least one server/node parameters and assigns a secondary server/node status in order to thereby route the traffic of the seed server/node upon detecting a failure/alert is generated in order to effectively implement the high availability of server/nodes within the cluster 120-150 of the cloud network 160.

The high availability manager 190 described herein can be a bridge architecture that is connected to a plurality of server/nodes 110 within the cluster 120-150 for monitoring the status and working of the server/nodes 110 within the cluster 120 of the cloud network 160. The high availability manager 190 generates a message that includes the cluster information with respect to the seed server/node 240 and transmits to the available server/nodes 110 within the cluster 120-150 by alerting the status of the seed node 240 within the cluster 120-150. The high availability manager 190 typically receives the applications 230 with respect to the customer and effectively assigns the application to the appropriate seed server/node 240 by ensuring the high availability of resources within the cluster 120-150.

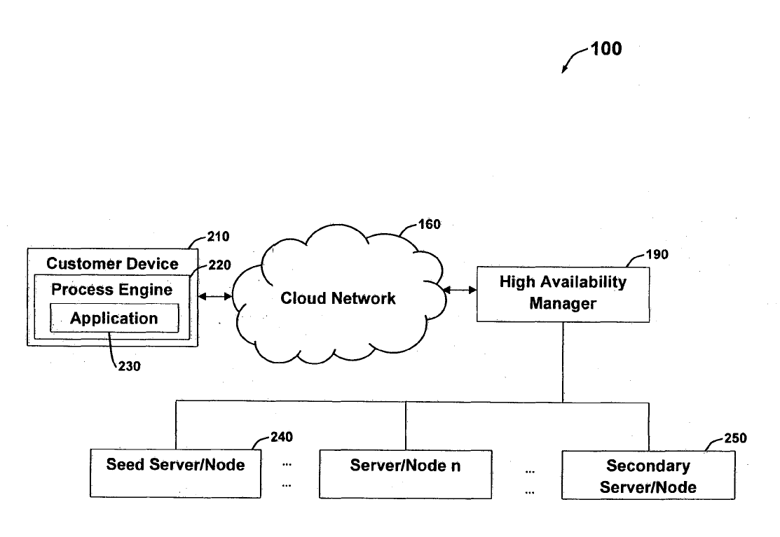

FIG. 2 illustrates a block diagram 200 of the high availability manager 190 for implementing high availability of server/node 110 within the cluster 120-150 of the cloud network 160, in accordance with the disclosed embodiments. Note that in FIGS. 1-3 identical parts or elements are generally indicated by identical reference numerals. The high availability implementation system 100 receives the application 230 with respect to the client 165-180 in the cloud network 160 in order thereby transfer the application 230 to the high availability manager 190. The client 165-180 can interact with a customer device, a typical data processing system as depicted in FIG. 1 having a process engine to submit the application 230 within the network 160.

The high availability manager 190 configured in associations with the server/nodes 110 of the cluster 120-150 typically receives the applications with respect to the customer/client 165-180 of the cluster 120-150 in the cloud network 160 in order to assign the application 230 to a server/node 110 within the cluster 120-150. The high availability manager 190 manages failures in the cluster 120-150 by providing a high availability service using a small number of physical nodes. The high availability manager 190 according to the present invention improves the reliability of the cluster 120-150 by providing effective services and requires a low management cost while not degrading the efficiency of a node although nodes for providing a service increase in number. Therefore, the high availability manager 190 can effectively overcome the problems of the system according to the related art, such as low availability, low resource utilization, and software or hardware failure.

The high availability system 100 for managing failure in the cluster 120-150 can provide stable services through high extendibility for progressing services related to very important business task or Infra related service and have high efficiency, thereby requiring a low management cost. The high availability manager 190 also maintains the information of the secondary server/node 250 with respect to the application 230 by actively monitoring the operability and availability of the seed server/node 240. The secondary server/node 250 can act as mirror server/node of the seed server/node 240 in order thereby ensures the processing of the applications within the cluster 120-150 in a failure mode. The seed server/node (or) the primary server/node 240 within the cluster 120-150 is determined based on the functional aspects of the application and the correlation identity of the customer.

The secondary server/node 250 within the cluster 120-150 is determined based on the server/node parameters including but not limited to, current usage history of the server/node, past usage history of the server/node and ping time of the server/node 110. Such as system and method for implementing high availability of server/nodes 110 in the cluster 120-150 can be effectively adapted in ensuring the availability of server/nodes such as databases, file systems, network addresses, or other resources for applications which require a high degree of dependability, such as electronic commerce websites and other business applications.

FIGS. 1-3 are intended as an example, and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, Windows, UNIX, LINUX, and the like. The following discussion is intended to provide a brief, general description of suitable computing environments in which the system and method may be implemented.

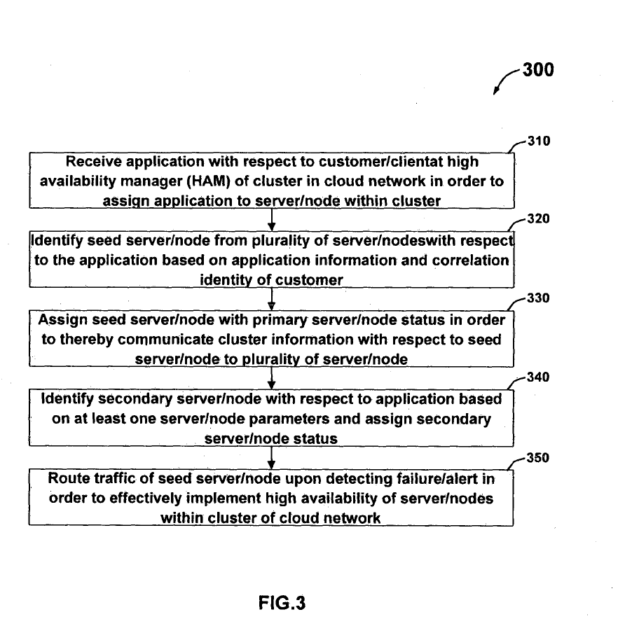

FIG. 3 illustrates a high level flow chart of operations illustrating logical operational steps of a method 300 for implementing high availability of server/node within a cluster of a cloud network, in accordance with the disclosed embodiments. The method 300 described herein can be deployed as process software in the context of a computer system or data-processing system as that depicted in FIGS. 1-3. The application 230 with respect to the customer/client 165-180 can be received at the high availability manager (HAM) 190 of the cluster 120-150 in the cloud network 160 in order to assign the application to the server/node 110 within the cluster 165, as illustrated at the block 310. The seed server/node 240 from the plurality of server/nodes 110 within the cluster 120-150 can be identified with respect to the application 230 based on the application information and correlation identity of the customer, as depicted at block 320.

Note that the correlation identity with respect to the customer can be generated using the technology disclosed in the patent application number 817/CHE/2013 dated Feb. 25, 2013. The seed server/node 240 can be assigned with the primary server/node status in order to thereby communicate the cluster information with respect to the seed server/node 110 to the plurality of server/node located within the cluster 120-150, as shown at the block 330. The secondary server/node 250 with respect to the application 230 can be identified based on at least one server/node parameters and assigned a secondary server/node status in order to thereby route the traffic of the seed server/node upon detecting a failure/alert is generated in order to effectively implement the high availability of server/nodes 110 within the cluster 120-160 of the cloud network 160, as illustrate at blocks 340 and 350 respectively.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

I/We claim:

1. A system for implementing high availability of the server/nodes in a cluster of a cloud network, comprising:
a high availability manager for receiving an application with respect to a customer/client of a cluster in a cloud network in order to assign the application to a server/node within the cluster;
an application information and correlation identity of the customer for identifying a seed server/node having a plurality of server/nodes within the cluster wherein the seed server/node can be assigned with a primary server/node status in order to thereby communicate the cluster information with respect to the seed server/node to the plurality of server/node located within the cluster; and
a secondary server/node with respect to the application can be identified based on at least one server/node parameters and assigned a secondary server/node status in order to thereby route the traffic of the seed server/node upon detecting a failure/alert is generated in order to effectively implement the high availability of server/nodes within the cluster of the cloud network.

2. The system of claim 1 wherein the high availability manager can be a bridge architecture that is connected to the plurality of server/nodes within the cluster for monitoring the status and working of the server/nodes within the cluster of the cloud network.

3. The system of claim 1 wherein the high availability manager generates a message that includes the cluster information with respect to the seed server/node and transmits to the available server/nodes within the cluster by alerting the status of the seed node within the cluster.

4. The system of claim 1 wherein the high availability manager receives the applications with respect to the customer and effectively assigns the application to the appropriate seed server/node by ensuring the high availability of resources within the cluster.

5. The system of claim 1 wherein the high availability manager maintains the information of the secondary server/node with respect to the application by actively monitoring the operability and availability of the seed server/node.

6. The system of claim 1 wherein the secondary server/node acts as mirror server/node of the seed server/node in order thereby ensures the processing of the applications within the cluster in a failure mode.

7. The system of claim 1 wherein the seed server/node within the cluster is determined based on the functional aspects of the application and the correlation identity of the customer.

8. The system of claim 1 wherein the secondary server/node within the cluster is determined based on at least one of the following parameters of the server/node:
current usage history of the server/node;
past usage history of the server/node; and
ping time of the server/node.

9. A method for Such as system and method for implementing high availability of the server/nodes in a cluster of a cloud network, comprising:
receiving an application with respect to a customer/client at a high availability manager (HAM) of a cluster in a cloud network in order to assign the application to a server/node within the cluster.
identifying a seed server/node from a plurality of server/nodes within the cluster with respect to the application based on the application information and correlation identity of the customer in order to thereby assign the seed server/node with a primary server/node status to communicate the cluster information with respect to the seed server/node to the plurality of server/node located within the cluster.
identifying a secondary server/node with respect to the application based on at least one server/node parameters and assigning a secondary server/node status in order to thereby route the traffic of the seed server/node upon detecting a failure/alert is generated in order to effectively implement the high availability of server/nodes within the cluster of the cloud network.

10. The method of claim 9 further comprising:
maintaining information of the secondary server/node with respect to the application using the high availability manager by actively monitoring the operability and availability of the seed server/node wherein said secondary server/node can act as mirror server/node of the seed server/node in order thereby ensures the processing of the applications within the cluster in a failure mode; and
determining the seed server/node within the cluster based on the functional aspects of the application and the correlation identity of the customer.
